(19) United States
(12) Patent Application Publication
(10) Pub. No.: US 2023/0342414 A1
(43) Pub. Date: Oct. 26, 2023

(54) SYSTEMS AND METHODS FOR MULTI-FIDELITY DATA AGGREGATION USING CONVOLUTIONAL NEURAL NETWORKS

(71) Applicant: Yongming Liu, Chandler, AZ (US)

(72) Inventor: Yongming Liu, Chandler, AZ (US)

(73) Assignee: Arizona Board of Regents on behalf of Arizona State University, Tempe, AZ (US)

(21) Appl. No.: 18/129,431

(22) Filed: Mar. 31, 2023

Related U.S. Application Data
(60) Provisional application No. 63/325,939, filed on Mar. 31, 2022.

(51) Int. Cl. G06F 17/15

(52) U.S. Cl. CPC G06F 17/153

(57) ABSTRACT

A machine-learning framework for multi-fidelity modeling provides three components: multi-fidelity data compiling, multi-fidelity perceptive field and convolution, and deep neural network for mapping. This framework captures and utilizes implicit relationships between any high-fidelity datum and all available low-fidelity data using a defined local perceptive field and convolution. First, the framework treats multi-fidelity data as image data and processes them using a CNN, which is very scalable to high dimensional data with more than two fidelities. Second, the flexibility of nonlinear mapping facilitates the multi-fidelity aggregation and does not need to assume specific relationships among multiple fidelities. Third, the framework does not assume that multi-fidelity data are at the same order or from the same physical mechanisms (e.g., assumptions are needed for some error estimation-based multi-fidelity model).

### CROSS REFERENCE TO RELATED APPLICATIONS

This is a U.S. Non-Provisional Pat. Application that claims benefit to U.S. Provisional Pat. Application Serial No. 63/325,939 filed 31 Mar. 2022, which is herein incorporated by reference in its entirety.

### GOVERNMENT SUPPORT

This invention was made with government support under NNX17AJ86A awarded by the National Aeronautics and Space Administration. The government has certain rights in the invention.

### FIELD

The present disclosure generally relates to aggregating multi-fidelity data, and in particular, to a system and associated method for aggregating and identifying mappings between multi-fidelity data using convolutional neural networks.

### BACKGROUND

In many domains in science and engineering, multiple computational and experimental models are generally available to describe a system of interest. These models differ from each other in the level of fidelity and cost. Typically, computationally or experimentally expensive high-fidelity (HF) models describe the system with a high accuracy (e.g., finer scale simulation or high-resolution testing). In contrast, low-fidelity (LF) models take less time to run but are less accurate. Examples of the different levels of fidelities can be simplified/complex mathematical models, coarser/finer discretization the governing equations, and experimental data with different techniques. In recent years, there have been growing interests in utilizing multi-fidelity (MF) models which combine the advantages of HF and LF models to achieve a required accuracy at a reasonable cost. The approaches to combine fidelities can be categorized into three groups: adaptation, fusion, and filtering. Adaptation strategy uses adaptation to enhance LF models with information from HF models while the computation proceeds. Fusion approaches evaluate LF models and HF models and then combine information from all outputs. Filtering approaches use the HF model only if the LF model is inaccurate, or when the candidate point meets some criterion.

The concept of multi-fidelity has been explored extensively in surrogate modeling, such as Gaussian process (GP). However, limitations of GP in MF modeling still exist, e.g., difficulties during optimization, approximations of discontinuous functions, and high-dimensional problems.

It is with these observations in mind, among others, that various aspects of the present disclosure were conceived and developed.

### BRIEF DESCRIPTION OF THE DRAWINGS

FIGS. 1A-1C are a series of graphical representations showing relationships between high-fidelity data and low-fidelity data, respectively corresponding to a point-to-point relationship, a point-to-domain relationship, and sequential advancement of a local domain in the space of low-fidelity data descriptive of the relationship between low-fidelity data and high-fidelity data.

FIG. 2 is a graphical representation showing a simplified framework including a neural network architecture for capturing the relationship between high-fidelity data and corresponding low-fidelity data.

FIG. 3 is a simplified diagram showing a framework for Multi-fidelity Data Aggregation using Convolutional Neural Networks.

FIGS. 4A-4C are graphical representations showing example input matrices for multi-source and multi-fidelity data aggregation for scenarios of (a) two-dimension input, (b) two low-fidelity models, and (c) utilizing first derivatives of the low-fidelity model.

FIGS. 5A-5G are a series of graphical representations showing approximations from Multi-fidelity Data Aggregation using Convolutional Neural Networks (MDA-CNN) for seven numerical examples.

FIGS. 6A and 6B are graphical representations showing a stress analysis test on a microstructure of a 2D plate, applied forces, and boundary conditions as analyzed using the architecture of FIG. 3, where FIG. 6A shows a high-fidelity model with a mesh of 300 × 300 can precisely represent the details of the microstructure and where FIG. 6B shows a low-fidelity model which only has a mesh of 50 × 50.

FIGS. 7A and 7B are graphical representations showing a von Mises stress field of high-fidelity (FIG. 7A) and low-fidelity (FIG. 7B) model with (160, 190, 230) GPa for a Young’ modulus of a three-phase material.

FIG. 8 is a graphical representation showing comparison between low- and high-fidelity results.

FIG. 9 is a graphical representation showing a comparison of predicted results with high-fidelity results.

FIG. 10 is a graphical representation showing comparison of computational cost between the MDA-CNN framework of FIG. 3 and single-fidelity HF model.

FIG. 11 is an illustration showing an aluminum 2024-T3 plate with an initial center-through crack under fatigue loading.

FIG. 12 is a graphical representation showing a comparison between low- and high-fidelity fatigue life data at different crack lengths for four fatigue crack growth trajectories.

FIG. 13 is a graphical representation showing results of fatigue crack growth trajectories using the MDA-CNN framework of FIG. 3

FIGS. 14A and 14B are graphical representations showing result comparisons for illustration of the effect of convolutional layer of the MDA-CNN framework of FIG. 3, respectively corresponding to a continuous function with linear relationship, and a continuous function with nonlinear relationship.

FIGS. 15A and 15B are graphical representations showing result comparison for input tables with and without low fidelity gradient information;

FIG. 16 is a process flow diagram showing a method for implementation of the MDA-CNN framework of FIG. 3.

FIG. 17 is a simplified diagram showing an exemplary computing system for implementation of the MDA-CNN framework of FIG. 3.

Corresponding reference characters indicate corresponding elements among the view of the drawings. The headings used in the figures do not limit the scope of the claims.

### DETAILED DESCRIPTION

### 1. Introduction

Multi-fidelity data exist in almost every engineering and science discipline, which can be from simulation, experiments, and a hybrid form. High fidelity data are usually associated with higher accuracy and expense (e.g., high resolution experimental testing or finer scale simulation), while low-fidelity data are on the opposite side in terms of the accuracy and cost. Multi-fidelity data aggregation (MDA) in this context refers to the process of combining two or multiple sources of different fidelity data to have a high accuracy estimation and low computational cost. MDA has a wide range of application in engineering and science, such as multiscale simulation, multi-resolution imaging, and hybrid simulation-testing.

The present disclosure outlines a framework for multi-fidelity modeling called Multi-fidelity Data Aggregation using Convolutional Neural Networks (MDA-CNN). The MDA-CNN architecture includes three components: a multi-fidelity data compiling section, a multi-fidelity perceptive field and convolution section, and a deep neural network model for mapping. This framework captures and utilizes implicit relationships between high-fidelity data and available low-fidelity data using a defined local perceptive field and convolution.

Most existing strategies rely on the collocation method and interpolation, which focuses on the single point relationship. As such, the framework outlined herein has several unique benefits. First, the framework treats the multi-fidelity data as image data and processes them using CNN, which is very scalable to high dimensional data with more than two fidelities. Second, the flexibility of nonlinear mapping in neural network facilitates the multi-fidelity aggregation and does not need to assume specific relationships among multiple fidelities. Third, the framework does not assume that multi-fidelity data are at the same order or from the same physical mechanisms (e.g., assumptions are needed for some error estimation-based multi-fidelity model). Thus, the framework can handle data aggregation from multiple sources across different scales, such as different order derivatives and other correlated phenomenon data in a single framework. The framework is validated using extensive numerical examples and experimental data with multi-source and multi-fidelity data.

In many domains in science and engineering, multiple computational and experimental models are generally available to describe a system of interest. These models differ from each other in the level of fidelity and cost. Typically, computationally or experimentally expensive high-fidelity (HF) models describe the system with a high accuracy (e.g., finer scale simulation or high-resolution testing). In contrast, low-fidelity (LF) models take less time to run but are less accurate. Examples of the different levels of fidelities can be simplified/complex mathematical models, coarser/finer discretization the governing equations, and experimental data with different techniques. In recent years, there have been growing interests in utilizing multi-fidelity (MF) models which combine the advantages of HF and LF models to achieve a required accuracy at a reasonable cost. The approaches to combine fidelities can be categorized into three groups: adaptation, fusion, and filtering. Adaptation strategy uses adaptation to enhance LF models with information from HF models while the computation proceeds. Fusion approaches evaluate LF models and HF models and then combine information from all outputs. Filtering approaches use the HF model only if the LF model is inaccurate, or when the candidate point meets some criterion.

The concept of multi-fidelity has been explored extensively in surrogate modeling, such as Gaussian process (GP). However, limitations of GP in MF modeling still exist, e.g., difficulties during optimization, approximations of discontinuous functions, and high-dimensional problems. On the contrary, neural networks (NNs) can deal with arbitrary nonlinearities in high dimensions. Recently, efforts of applying neural networks as surrogate models have been made to achieve multi-fidelity modeling. One method uses cheap low-fidelity computational models to start training the NN and switch to higher-fidelity training data when the overall performance of the NN stops increasing. Computational models with varying levels of accuracies are needed to generate training data for the NN. This belongs to the filtering strategy. Other methods of applying NNs in multi-fidelity problems mainly use adaption. One work uses a LF physics-constrained neural network as the baseline model, and use a limited amount of HF data to train a second neural network to predict the difference between the low- and high-fidelity models. Another work proposes a composite NN including three NNs: the first NN is trained using the low-fidelity data and coupled to two high-fidelity NNs to discover and exploit nonlinear and linear relationships between low-and high-fidelity data, respectively. Another work constructs a two-level neural network, where a large set of low-fidelity data are utilized to accelerate the construction of a high-fidelity surrogate model with a small set of high-fidelity data.

An important feature of applying NNs to achieve multifidelity modeling is to learn the relationship between low-and high-fidelity model. Current attempts focus on the relationship between HF data and LF data having the identical inputs. Thus, a large portion of LF data is not efficiently utilized in the process of learning the appropriate relationships.

The present disclosure outlines the framework for MDA-CNN . First, compared with GP models, the discontinuous functions can be handled by the framework due to the flexibility of function approximation of NNs. Also, the framework is very scalable to high dimensional data due to the convolutional operation. Second, compared with the current NN models, the framework utilizes all available low-fidelity data, instead of just using the collocated low-fidelity data, to fully exploit the relationship between low-fidelity models and high-fidelity models. In addition, the framework includes an integrated NN, rather than a composite of several disparate NNs. Thus, only one-time training is needed. Third, the framework is not limited to two levels of fidelity (e.g., high-fidelity and low-fidelity) and can be extended to cases with data sets at multiple levels of fidelities. Also, the framework does not assume that multi-fidelity data are at the same order or from the same physical mechanisms (e.g., assumptions are needed for some error estimation-based multi-fidelity model). Thus, the framework can handle data aggregation from multiple sources across different scales, such as different order derivatives and other correlated phenomenon data.

The disclosure is organized as follows. First, in section 2, the methodology of the MDA-CNN framework is presented. Next, in section 3, the MDA-CNN framework is validated with extensive numerical examples. Following that, in section 4, the MDA-CNN framework is applied in two engineering problems, stress prediction with finite element analysis and fatigue crack growth. After that, in section 5, discussions are given to illustrate the benefits and limitations of the proposed framework. Section 6 provides a summary of concepts outlined herein. Section 7 outlines a method or process applied by the framework outlined in Section 2. Section 8 outlines an example computing device for implementation of the framework as a computer-implemented system.

### 2. Multi-Fidelity Data Aggregation Using Convolutional Neural Networks

Suppose a n-dimensional random vector y ∈ ℝⁿ is mapped through a computational model to obtain a desired output quantity Q(y) ∈ ℝ. Let Q_{L}(y) and Q_{L}(y) denote the approximated values of the quantity Q(y) by a low-fidelity (LF) computational model and a high-fidelity (HF) computational model, respectively. Consider a general relationship between the two computational models as:

$${Q}_{H} \left(y\right) = F \left(y , {Q}_{L} \left(y\right)\right) \qquad \text{(1)}$$

where F(•) is an unknown function that captures the relationship between low- and high-fidelity quantities. F(•) can be either linear or nonlinear.

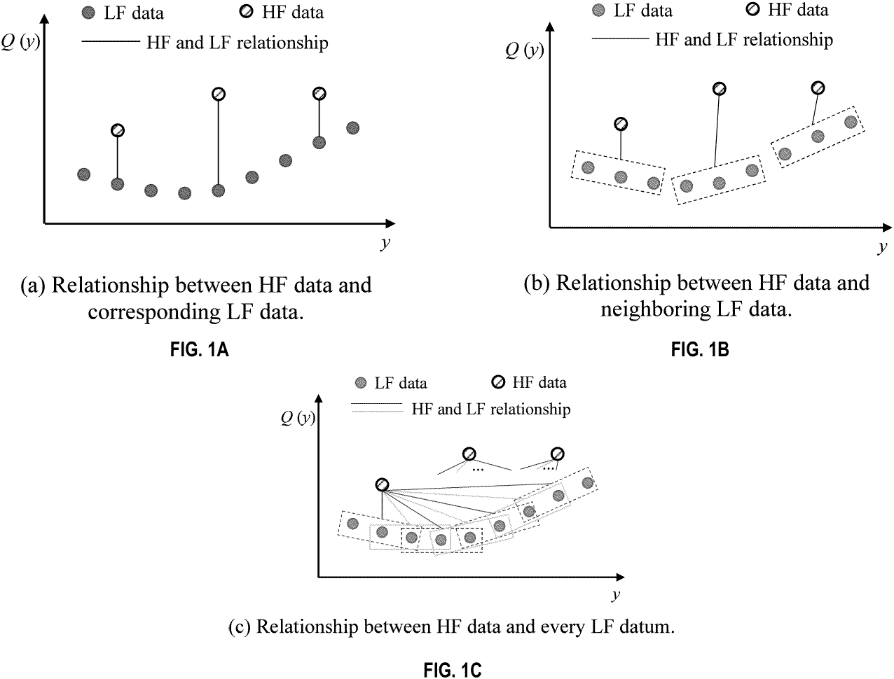

FIGS. 1A-1C illustrate relationships between HF data and LF data. FIG. 1A shows a point-to-point relationship in which the multi-fidelity model learns the relationship between low-fidelity data and high-fidelity data at the same inputs. FIG. 1B shows a point-to-domain relationship in which the proposed idea is to learn the relationship between the high-fidelity data and the low-fidelity data in a neighborhood of y_{H} (the rectangular box). FIG. 1C shows an expansion on the above idea to learn the relationship between a high-fidelity datum and all available low-fidelity data by moving the local domain (the rectangular box) in the space of low-fidelity data sequentially.

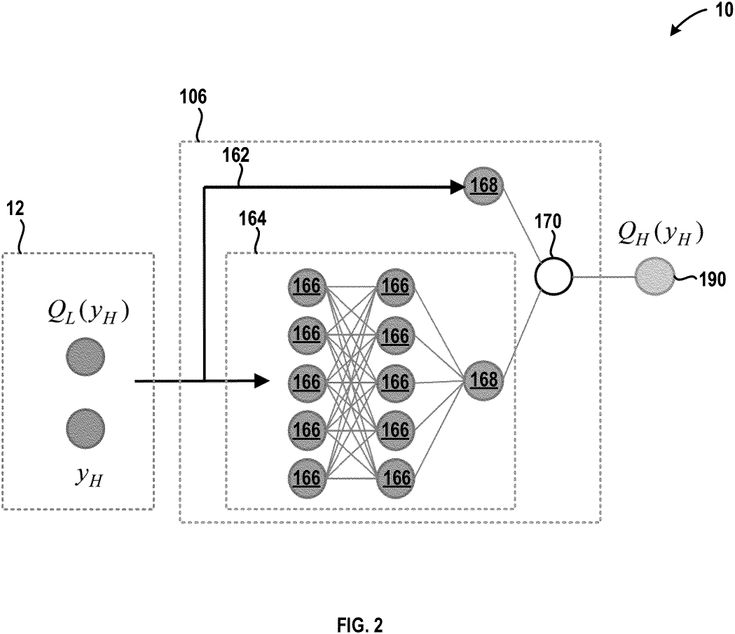

The relationship in Eq. (1) can be presented in FIG. 1A when y is one dimensional. For each high-fidelity data point Q_{H}(y_{H}) at y_{H}, there exists a corresponding low-fidelity Q_{L}(y_{H}) data point. The multi-fidelity strategy is to capture the relationship between Q_{H}(y_{H}) and Q_{L}(y_{H}). To learn the relationship F(•), a simplified framework 10 is shown in FIG. 2 having an input layer 12 with two input neurons : representing y_{H} and Q_{L}(y_{H}). An output layer 190 of the simplified framework 10 of FIG. 2 can include a single output neuron representing Q_{H}(y_{H}).

The simplified framework 10 shown in FIG. 2 includes a deep neural network model 106 that includes a plurality of hidden layers between the input layer 12 and output layer 190 defining two parts: linear mapping and nonlinear mapping. The linear mapping can be learned through a skip connection 162 and the nonlinear mapping can be learned through a plurality of fully connected layers 164. The outputs for the linear mapping and nonlinear mapping are then added together at a summation neuron 170 before being connected to the output layer 190. A first plurality of neurons 166 of the plurality of fully connected layers 164 use nonlinear activation functions, and a second plurality of neurons 168 of the deep neural network model 106 at the outputs of the plurality of fully connected layers 164 and the skip connection 162 use linear activation functions. Decomposition of the hidden layers into linear and nonlinear parts is inspired by the concept of ResNet where a direct link is used to learn a residual mapping between low-fidelity and high-fidelity data rather than the original function. It is easier to optimize the residual mapping than to optimize the original one. If there are no more things for the nonlinear fully connected layers to learn, the simplified framework 10 shown in FIG. 2 simply “learns” the mapping as being zero. Colloquially, this demonstrates that it is easier for a neural network to learn a mapping closer to zero than a linear mapping.

The simplified framework 10 shown in FIG. 2 learns the relationship between low-fidelity data and high-fidelity data at the same inputs, i.e., a point-to-point relationship (see FIG. 1A). With the multi-fidelity strategy applied by the simplified framework 10, the low-fidelity data that can be used are limited to the data with the same inputs as the corresponding high-fidelity data at y_{H}. A large portion of low-fidelity data is not effectively used to learn the relationship. In order to take those unused low-fidelity data into account, a method is schematically presented in FIG. 1B for learning relationships between high-fidelity data and the low-fidelity data in the neighborhood of y_{H} (shown in the rectangular box in FIG. 1B). In this manner, a multi-fidelity model that considers a “neighborhood” as demonstrated in FIG. 1B can learn a point-to-domain relationship between low-fidelity data and high-fidelity data. Thus, more information from a low-fidelity model can be incorporated to assist the multi-fidelity strategy. More generally, the above method can be expanded to learn the relationship between an instance of high-fidelity datum and all available low-fidelity data as shown in FIG. 1C, achieved by moving or otherwise advancing the local domain (the rectangular box in FIG. 1C) along the space of low-fidelity data sequentially. This “sliding window” operation captures the relationship between each instance of high-fidelity datum and each local domain of low-fidelity data. In one aspect, this “sliding window” operation can be considered in a similar vein to the local receptive field concept and convolutional operation. This is the reason why CNNs can be employed to perform multi-fidelity data analytics. The rest of this section describes the implementation of the concepts in FIG. 1C through a proposed neural network model: Multi-fidelity Data Aggregation using Convolutional Neural Networks (MDA-CNN).

The simplified framework 10 of FIG. 2 illustrates a simplified example of the deep neural network model 106 for capturing the relationship between HF data and corresponding LF data (corresponding to concepts outlined above with respect to FIG. 1A). As discussed, while the simplified framework 10 can learn a mapping between high-fidelity data and low-fidelity data, the simplified framework 10 can be limited in that it does not effectively use all available data to learn relationships therebetween.

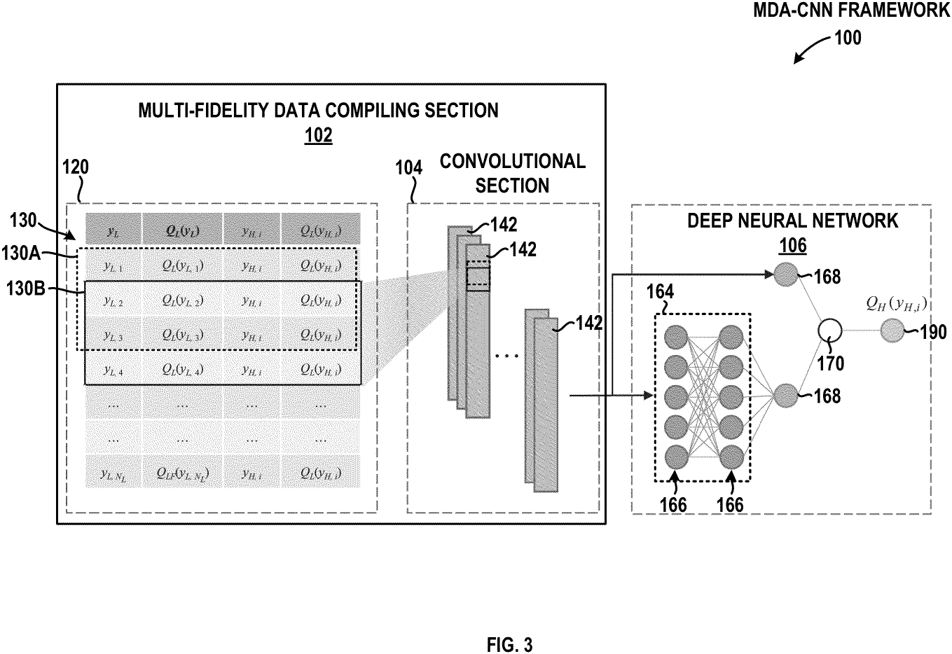

An “MDA-CNN” framework 100 is shown in FIG. 3, and includes a multi-fidelity data compiling section 102 that organizes input data and applies it to a convolutional section 104, and the deep neural network model 106 discussed above with reference to FIG. 2. The multi-fidelity data compiling section 102 receives low-fidelity data and high-fidelity data and constructs a multi-fidelity data matrix 120 that correlates one or more low-fidelity data points of a plurality of low-fidelity data points with one or more high-fidelity data points of a plurality of high-fidelity data points.

The MDA-CNN framework 100 can apply a local receptive field 130 that “moves” along the multi-fidelity data matrix 120 in an iterative fashion to capture a subset of the one or more low-fidelity data points and their respective high-fidelity data points across a plurality of iterations (e.g., a new subset captured at each iteration).

The multi-fidelity data compiling section 102 provides inputs to the convolutional section 104, which constructs a plurality of feature maps within a convolutional layer of a plurality of convolutional layers of the convolutional section. Each feature map of the plurality of feature maps corresponds to a respective subset of the one or more low-fidelity data points and their respective high-fidelity data points captured within the local receptive field 130.

The output of the convolutional section 104 is provided to the deep neural network model 106, which identifies mappings between the plurality of low-fidelity data points and the plurality of high-fidelity data points based on the plurality of feature maps within the convolutional layer by decomposition of the hidden layers into linear and nonlinear parts.

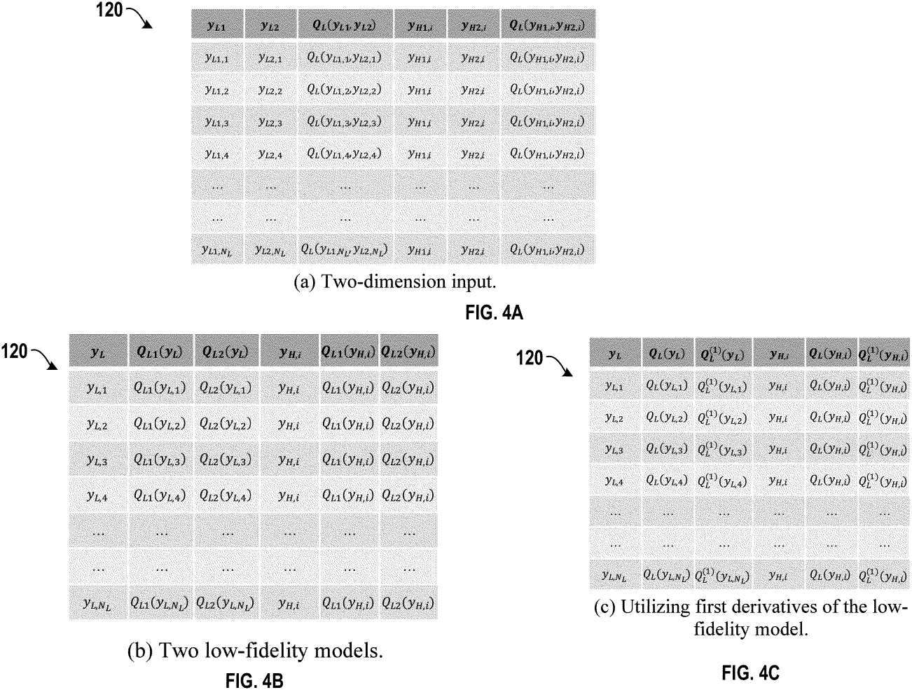

Compared with the simplified framework 10 discussed above with reference to FIG. 2, the output data of the MDA-CNN framework 100 are still Q_{H}(y_{H,i})i = 1, ..., N_{H}, where N_{H} is the total quantity of high-fidelity data. However, instead of simply inputting y_{H,i} and Q_{L}(y_{H,i}), i = 1, ..., N_{H}, as demonstrated with the simplified framework 10, all of the low-fidelity data Q_{L}(y_{L,j}),j = 1,..., N_{L} can also be used as inputs to the MDA-CNN framework 100 shown in FIG. 3, where N_{L} is the total quantity of low-fidelity data. The input data are compiled in the form of the multi-fidelity data matrix 120, one example of which is shown in FIG. 3 with additional examples shown in FIGS. 4A-4C. In this manner, for a given set of multi-fidelity data with N_{H} high-fidelity data points, there are a total number of N_{H} input tables. In any i - th input table, where i = 1,...,N_{H}, there are at least four columns, each representing y_{L}, Q_{L}(y_{L}), Y_{H,i} and Q_{L}(y_{H,i}). There are a total number of N_{L} rows. For the first two columns, y_{L} and Q_{L}(y_{L}), the table values are y_{L,j}, Q_{L}(y_{L,j}), j = 1,..., N_{L}, respectively, for the j - th row. For the last two columns, the table values are y_{H,i} and Q_{L}(y_{H,i}), respectively, and are the same for each row. Being complied into the multi-fidelity data matrix 120 in the above manner, all the available low-fidelity data are utilized for the neural network model 106 to learn the relationship between low-and high-fidelity data. As will be discussed in further detail herein, the multi-fidelity data matrix 120 can be adapted to accommodate multi-dimensional multi-fidelity data.

The input to the MDA-CNN framework 100 is the multi-fidelity data matrix 120, instead of a vector as is illustrated in FIG. 2. Analogous to an image, the multi-fidelity data matrix 120 is provided as input to the convolutional section 104. The black rectangular window shown in FIG. 3 at the multi-fidelity data matrix 120 illustrates the local receptive field 130. In one non-limiting example shown in FIG. 3, the local receptive field 130 can be a 3 × 4 region, which can be understood as learning the relationship between Q_{H}(y_{H,i}) and the integration of Q_{L}(Y_{H,i}) at Y_{H,i}, Q_{L}(Y_{L,2}) at y_{L,2}, Q_{L}(y_{L,3}) at y_{L,3}, and Qₗ(y_{L,4}) at y_{L,4}. This operation corresponds to the connection of a high-fidelity datum with a local domain of low-fidelity data discussed above with reference to FIG. 1C. Each row of the multi-fidelity data matrix 120 can be treated as a “unit”. The local receptive field 130 can include one unit or multiple units. Each local receptive field 130 can be associated with a hidden neuron in the convolutional section 104.

In the example of FIG. 3, a first local receptive field 130A is generated to capture a first subset of low-fidelity data points and their respective high-fidelity data points from the multi-fidelity data matrix 120. The output of the first local receptive field 130A is used to construct a first feature map at the convolutional section and detect a single type of relationship between the first subset of low-fidelity data points and their respective high-fidelity data points captured within the first local receptive field 130A. Next, a second local receptive field 130B is generated by “sliding down” or advancing the first local receptive field 130A by a row of the multi-fidelity data matrix 120 to capture a second subset of low-fidelity data points and their respective high-fidelity data points. The output of the second local receptive field 130B is similarly used to construct a second feature map at the convolutional section and detect a single type of relationship between the second subset of low-fidelity data points and their respective high-fidelity data points captured within the second local receptive field 130B. That is the fulfillment of moving the local domain of low-fidelity data (the rectangular box) to the “right” by one low-fidelity data point as shown in FIG. 1C.

Each respective position (and subset of captured information) of the local receptive field 130 is associated with a different hidden neuron in the convolutional section 104. This procedure is progressively conducted across the entire multi-fidelity data matrix 120, with each local receptive field 130 corresponding to a new hidden neuron in the convolutional section 104. A feature map 142 of a plurality of feature maps 142 connecting the multi-fidelity data matrix 120 to the convolutional section 104 is constructed for each local receptive field 130. The feature map 142 can detect a single type of localized feature of relationship between low-fidelity data and high-fidelity data. To learn a complete relationship, more than one feature map 142 is needed. Thus, a complete convolutional section 104 having one or more convolutional layers that constructs multiple different feature maps 142 is constructed as shown in FIG. 3.

Next, the deep neural network model 106 shown in FIG. 3 is applied to learn the linear/nonlinear mapping between high-fidelity data points and corresponding low-fidelity data points as captured through construction of the plurality of feature maps 142. As discussed, the deep neural network model 106 includes the plurality of hidden layers and defines two parts: linear mapping and nonlinear mapping. The linear mapping can be learned through the skip connection 162 and the nonlinear mapping can be learned through the plurality of fully connected layers 164. The outputs for the linear mapping and nonlinear mapping are then added together at the summation neuron 170 before being connected to the output layer 190. The first plurality of neurons 166 of the plurality of fully connected layers 164 use nonlinear activation functions, and the second plurality of neurons 168 of the deep neural network model 106 at the outputs of the plurality of fully connected layers 164 and the skip connection 162 use linear activation functions.

The multi-fidelity data matrix 120 shown as an example in FIG. 3 is configured for the bi-fidelity problem with one-dimensional y. It is noted that the multi-fidelity data matrix 120 is not limited to two levels of fidelity and can be extended to process datasets at multiple levels of fidelities and to deal with y having any dimension (see FIGS. 4A-4C, which show additional examples of the multi-fidelity data matrix 120 modified to accommodate multi-source and multi-dimensional data). In addition, if other information besides Q_{L} (y) from a low-fidelity model is useful, such as derivatives, it is also easy to be incorporated in the MDA-CNN framework 100. For those scenarios, the multi-fidelity data matrix 120 can be adapted at the multi-fidelity data compiling section 102 in FIG. 3 while leaving the rest of the MDA-CNN framework 100 (e.g., the configuration of the convolutional section 104 and the deep neural network model 106) unchanged. FIGS. 4A-4C respectively show extension of the multi-fidelity data matrix 120 for scenarios of two-dimensional y (FIG. 4A), two low-fidelity models (FIG. 4B), and utilizing first derivatives of the low-fidelity model (FIG. 4C), respectively. The basic idea for constructing the multi-fidelity data matrix 120 is that the “left” half of the multi-fidelity data matrix 120 includes the low-fidelity information, and the “right” half indicates the low-fidelity data corresponding to an available high-fidelity datum.

### 3. Numerical Experiments and Validation

Seven numerical examples are adopted for validating the MDA-CNN framework 100, including: continuous functions with linear relationship, discontinuous functions with linear relationship, continuous functions with nonlinear relationship, continuous oscillation functions with nonlinear relationship, phase-shifted oscillations, different periodicities, and 50-dimensional functions as shown in Table 1 (a)-(g), respectively.

The MDA-CNN framework 100 of FIG. 3 is used to obtain the multi-fidelity results, with the multi-fidelity data matrix 120 being adapted for each respective numerical example shown in Table 1. For Examples (a)-(d) of Table 1, the multi-fidelity data matrix 120 is organized similar to the example shown in FIG. 3. For Examples (e) and (f) of Table 1, the multi-fidelity data matrix 120 is organized similar to the example shown in FIG. 4C. The first derivative is calculated using the central difference method with a step size of 10⁻⁶. For example (g) of Table 1, the multi-fidelity data matrix 120 is organized similar to the example shown in FIG. 4A. Hyperparameters used for training the MDA-CNN framework 100 are listed in Table 2. In one implementation, for each numerical example, Adam optimization is employed to minimize the mean squared error. Two hidden layers with ten neurons per layer and hyperbolic tangent activation functions are employed for the fully connected layers 164. Table 2 also shows the number of low- and high-fidelity data used for training the MDA-CNN framework 100 for each example. For Examples (a)-(f) of Table 1, the low-fidelity data points and high-fidelity data points are uniformly selected. For Example (g) of Table 1, the low-fidelity data points and high-fidelity data points are randomly selected.

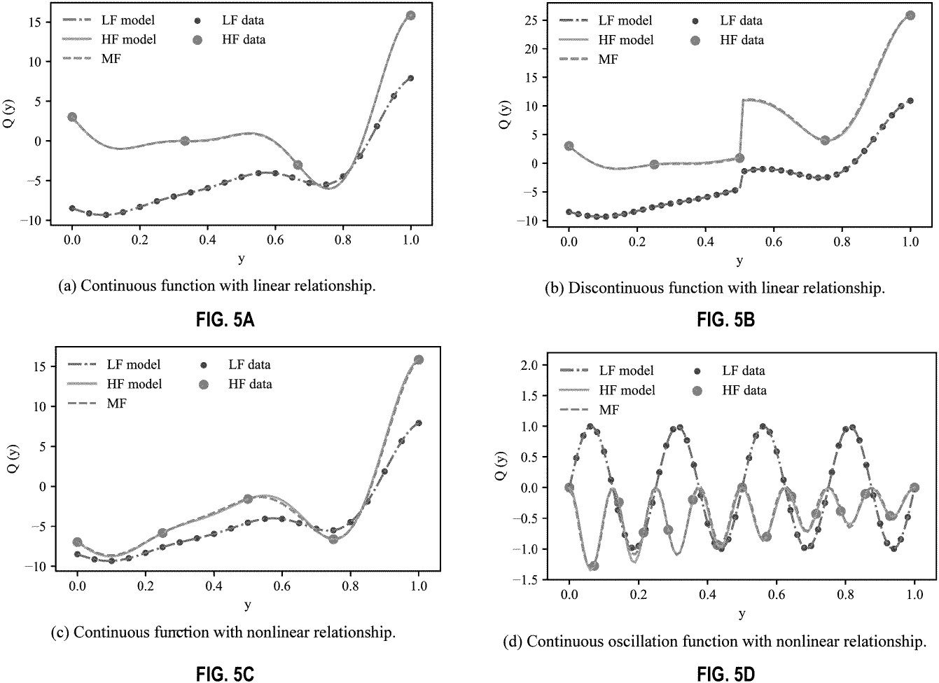

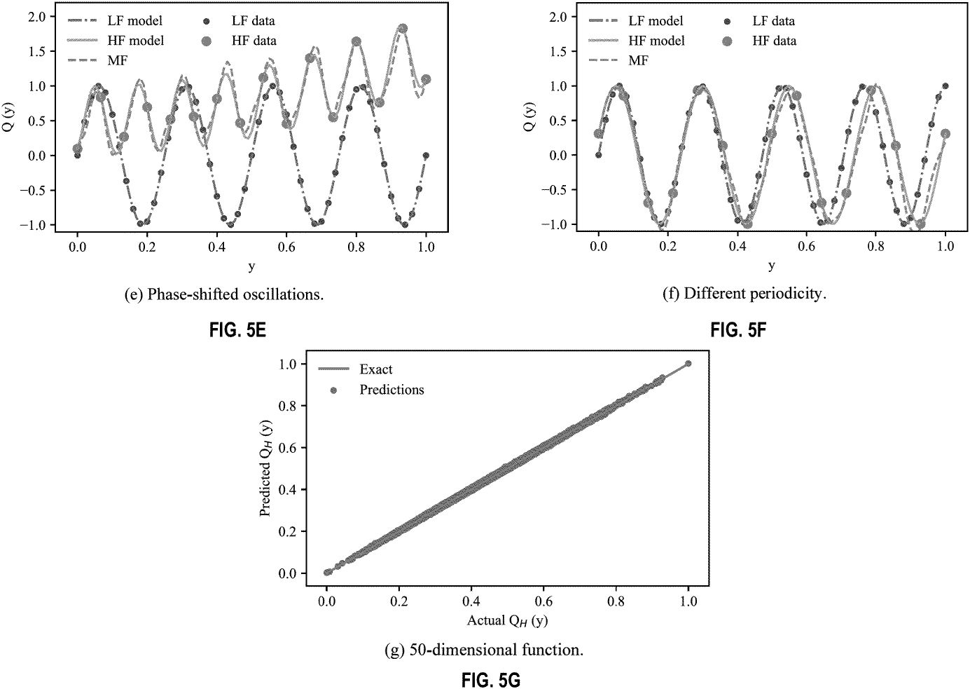

The results of the seven numerical examples are shown in FIGS. 5A-5G respectively. They are the comparison between the results from the MDA-CNN framework 100 and ground truth high fidelity models. The smaller points and larger points are the low-fidelity data and high-fidelity data used for training, respectively. The “dot-dashed”, solid, and dashed lines respectively indicate the plots from the low-, high- and multi-fidelity model. It can be seen that the results from the MDA-CNN framework 100 are almost identical with those from pure high-fidelity models for Examples (a)-(f). For Example (g), the predictions are made at 10,000 randomly locations. The predicted vs. actual value is plotted in FIG. 5G. The points are almost located on the solid line representing exact predictions. The prediction errors calculated by:

$$E r r o r = \left({Q}_{p r e d i c t e d} - {Q}_{a c t u a l}\right) / {Q}_{a c t u a l} \qquad \text{(2)}$$

are 0.0035, 0.0027 and 0.0179 for mean, standard deviation and maximum value, respectively. Therefore, a good accuracy can be achieved for all the numerical examples investigated.

TABLE 1

Low- and high-fidelity models for numerical examples.

| No. | | LF model | | HF model | |
|---|---|---|---|---|---|
| (a) | Continuous functions with linear relationship | Q_{L}(y) = 0.5(6y - 2)² sin(12y - 4) + 10(y - 0.5) - 5, 0≤y≤1 | (3) | Q_{H}(y) = (6y - 2) sin(12y - 4),0 ≤ y ≤ 1 | (4) |
| (b) | Discontinuous functions with linear relationship | $\begin{matrix}{Q}_{L} \left(y\right) = \\ \left\{\begin{matrix}0.5 {\left(6 y - 2\right)}^{2} sin \left(12 y - 4\right) + 10 \left(y - 0.5\right) , \\ 0 \leq y \leq 1 \\ 3 + 0.5 {\left(6 y - 2\right)}^{2} sin \left(12 - 4\right) + 10 \left(y - 0.5\right) , \\ 0.5 < y \leq 1\end{matrix}\right)\end{matrix}$ | (5) | ${Q}_{L} \left(y\right) = \left\{\begin{matrix}2 {Q}_{L} \left(y\right) - 20 y + 20 , \\ 0 \leq y \leq 0.5 \\ 4 + 2 {Q}_{L} \left(y\right) - 20 y + 20 , \\ 0.5 < y \leq 1\end{matrix}\right)$ | (6) |
| (c) | Continuous functions with nonlinear relationship | Q_{L}(y) = 0. 5(6y - 2)² sin(12y - 4) + 10(y - 0. 5) - 5, | (7) | Q_{H}(y) = (6y - 2)² sin(12y - 4) - 10(y - 1)² | (8) |
| (d) | Continuous oscillation functions with nonlinear relationship | Q_{L}(y) = sin(8πy), 0 ≤ y ≤ 1 | (9) | ${Q}_{H} \left(y\right) = \left(y - \sqrt{2}\right) {Q}_{L}^{2} \left(y\right) , 0 \leq y \leq 1$ | (10) |
| (e) | Phase-shifted oscillations | Q_{L}(y) = sin(8πy) | (11) | ${Q}_{H} \left(y\right) = {y}^{2} + {Q}_{L}^{2} \left(y + π / 10\right)$ | (12) |
| (f) | Different periodicities | ${Q}_{L} \left(y\right) = sin \left(6 \sqrt{2} π \text{} y\right)$ | (13) | Q_{H}(y) = sin(8πy + n/10) | (14) |
| (g) | 50-dimensional functions | $\begin{matrix}{Q}_{L} \left(y\right) = 0.8 {Q}_{H} \left(y\right) \\ - {\sum }_{i = 1}^{49} 0.4 {y}_{i} , {y}_{i + 1} - 50 , - 3 \leq {y}_{i} \leq 3\end{matrix}$ | (15) | $\begin{matrix}{Q}_{H} \left(y\right) = {\left({y}_{1} - 1\right)}^{2} + {\sum }_{i = 2}^{50} \left(2 {y}_{i}^{2} -\right) \\ {\left({y}_{i}\right)}^{2} , - 3 \leq {y}_{i} \leq 3\end{matrix}$ | (16) |

TABLE 2

Hyperparameters and number of low- and high-fidelity data used while training the MDA-CNN for numerical examples.

| No. | Number of epochs | Batch size | Learning rate | Regularization rate | Number of feature maps | Kernel width | Number of LF data | Number of HF data |
|---|---|---|---|---|---|---|---|---|
| (a) | 5,000 | 4 | | | | | 21 | 4 |
| (b) | 5,000 | 5 | | | | | 38 | 5 |
| (c) | 5,000 | 5 | | | | | 21 | 5 |
| (d) | 5,000 | 10 | 0.001 | 0.01 | 64 | 3 | 51 | 15 |
| (e) | 5,000 | 10 | | | | | 51 | 16 |
| (f) | 5,000 | 10 | | | | | 51 | 15 |
| (g) | 1,000 | 50 | | | | | 1,000 | 100 |

One significant difference between the MDA-CNN framework 100 discussed herein and others is the quantity of low-fidelity data used for learning relationships between low-fidelity data and high-fidelity data. In most previous approaches, only collocated low-fidelity data (e.g., collocated low-fidelity data having clear connections with high-fidelity data) are used. In the MDA-CNN framework 100 discussed herein, the convolutional section 104 enables efficient use of all available low-fidelity data. The results obtained from the deep neural network model 106 with and without the convolutional section 104 (e.g., of the simplified framework 10 and MDA-CNN framework 100) corresponding to FIG. 3 and FIG. 2, respectively, are also compared.

FIGS. 5A-5G show approximations from the MDA-CNN framework 100 for the seven numerical examples in Table 1. These approximations compare results from the MDA-CNN model applied by the MDA-CNN framework 100 discussed herein and “ground truth” high-fidelity models. For FIGS. 5A-5F, the smaller points and bigger points respectively indicate the low-fidelity data and high-fidelity data used for training. The dot-dashed, solid, and dashed lines are the plots from the low-fidelity, high-fidelity and multi-fidelity models. It can be seen that the results from the MDA-CNN framework 100 are almost identical with those from pure high-fidelity models. For FIG. 5G, the predictions are made at 10,000 random locations. The points are very close to the solid line representing exact predictions.

### 4. Engineering Application Examples

Following validation through the above numerical examples, the MDA-CNN framework 100 is applied in two engineering problems. The first engineering problem presented in Section 4.1 herein involves finite element stress analysis of a plate including multi-phase materials with random microstructures. The low-fidelity and high-fidelity models considered in this engineering problem presented in Section 4.2 herein are distinguished by coarse and fine mesh in the finite element analysis. The second engineering problem involves prediction of crack growth under fatigue loadings. The low-fidelity and high-fidelity data are from a simplified mechanical model and experimental measurements, respectively.

### 4.1 Finite Element Analysis With Random Microstructure

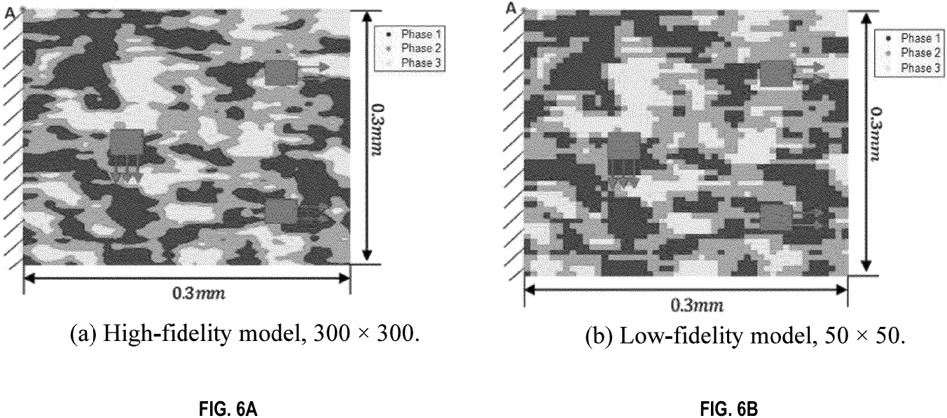

Consider a two-dimensional (2D) 0.3 mm × 0.3 mm plate including three-phase heterogeneous materials shown in FIGS. 6A and 6B. FIGS. 6A and 6B show the microstructure of the 2D plate, applied forces, and boundary conditions. Different colors indicate different phases of materials. The randomness in microstructures can affect the overall performance of small devices or components such as microelectromechanical systems (MEMSs) due to the compatible scale. Thus, the stress analysis due to the existence of microstructures is essential for either failure analysis or design. The microstructure is generated by using a recently developed Mixture Random Field model and is kept unchanged in all simulations. A high-fidelity model with a fine-grained mesh of 300 × 300 is illustrated in FIG. 6A which can precisely represent the details of the microstructure. FIG. 6B is the low-fidelity model which has a coarse-grained mesh of 50 × 50. Some of the microstructure details are lost due to the coarse-grained mesh shown in FIG. 6B. The nodes on the “left” edges of FIGS. 6A and 6B are fixed in both x and y directions. External body forces in either x or y directions with amplitude of 1 kN/mm² are distributed in the rectangular areas. The arrows along each rectangular area show directions of applied forces during finite element stress analysis. The structure is assumed to be under plane stress.

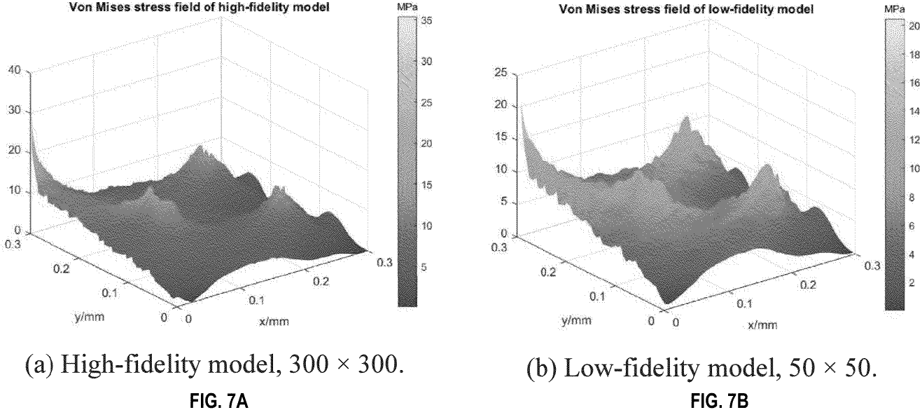

To avoid the high computational costs for the probabilistic analysis or design where repeated response function calls are needed, the numerically efficient multi-fidelity model is trained to learn the mapping from different material properties to responses of critical points. The Young’s modulus of the three materials are chosen as random variables for illustration purpose. Thus, the inputs are three-dimensional. Comparison between the von Mises stress fields calculated by the high-fidelity model and the low-fidelity model is presented in FIGS. 7A and 7B with the input vector of (160, 190, 230) gigapascal (GPa) for the Young’ modulus of the three-phase material, with FIG. 7A showing a von Mises stress field for the high-fidelity model and with FIG. 7B showing a von Mises stress field for the low-fidelity model. For both fidelity models, the stress concentration occurs at the point A shown in FIGS. 6A and 6B at the top left corner with (x,y) coordinates of (0, 0.3) mm. Point A can be regarded as the most “dangerous” point. Thus, the von Mises stress at point A is selected to be the output of the multi-fidelity model. It should be noted that any other location outputs can be selected, and the proposed method is not limited to the location in the simulation domain.

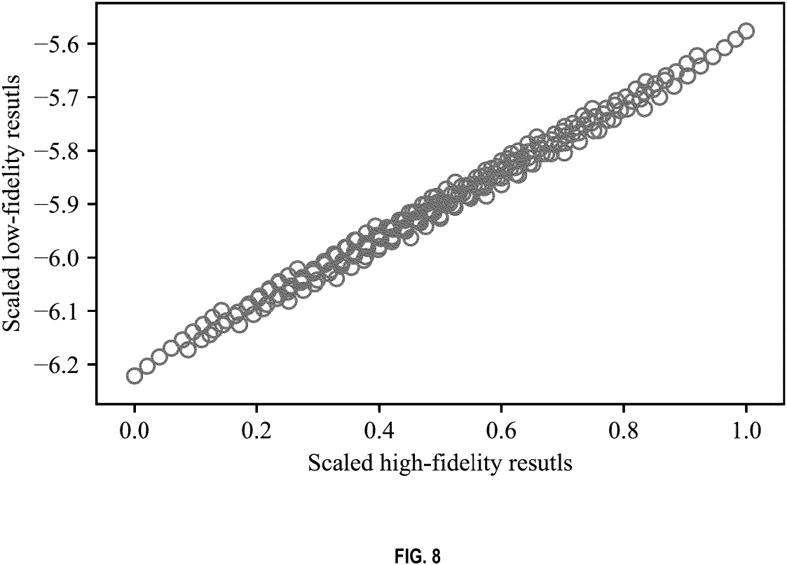

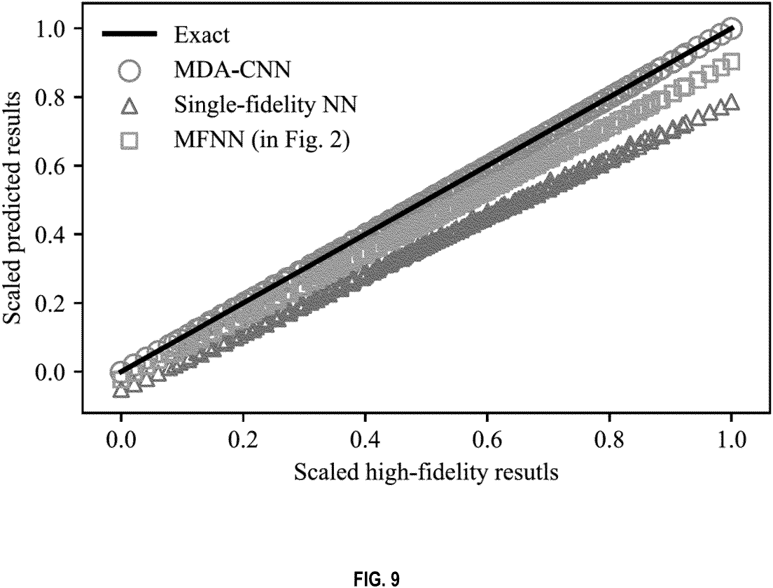

In this example, the three-dimensional input space for the low-fidelity (LF) model is uniformly selected from intervals of [150, 170], [180, 200], and [210, 250] GPa for three materials, respectively. The grid length (i.e., the distance between two adjacent points) in each interval is 5 GPa. The total number of LF data is 255. The comparison between low-fidelity results and high-fidelity results is shown in FIG. 8. The results are normalized by being subtracted by the minimum of the high-fidelity results and then divided by the difference between the maximum andminimum of the high-fidelity results. As shown, the low-fidelity results do not agree with the high-fidelity results. The root-mean-square error is 1840.3%, as shown in Table 3. However, the overall trend of the low-fidelity results and high-fidelity results match. That is, in general, the high-fidelity results increase as the low-fidelity results increase. The correlation between low-fidelity data and high-fidelity data in FIG. 8 shows an almost linear trend. The relationship shows local perturbations due to modeling error.

Next, the framework is applied for a more accurate prediction. In this example, the input space for the high-fidelity (HF) model is the grid from input vectors (155, 165), (185, 195), and (220, 230, 240) GPa. The total quantity of high-fidelity datum is 12. The MDA-CNN framework 100 discussed above with reference to FIG. 3 is used for the multi-fidelity modeling. Since the input of this problem is two-dimensional, the input table is designed according to FIG. 4A. There are 64 feature maps in the convolutional layer. 2 hidden layers with 10 neurons per layer and hyperbolic tangent activation functions are employed for the fully connected layers. Predictions are made at the 255 LF training data. The results from the MDA-CNN framework 100 are shown in FIG. 9. The circles are the predictions, and the black solid line represents the predictions equal to the ground truth (high-fidelity results). The agreement between the circles and the black line shows that good predictions can be obtained using the MDA-CNN framework 100. The RMSE is 1.2% as shown in Table 3. To show the necessity of the multi-fidelity modeling, a neural network is trained for prediction only using the 12 high-fidelity datum and is fully connected with 2 hidden layers each of which has 10 neurons. The results are shown in triangles in FIG. 9 and the RMSE is 38.9% in Table 3. Thus, using single-fidelity modeling is insufficient due to the insufficiency of HF data.

TABLE 3

RMSE (5) for different models.

| | LF | Single-fidelity NN | MFNN | MDA-CNN |
|---|---|---|---|---|
| RMSE | 1840.3 | 38.9 | 18.6 | 1.2 |

To show the effectiveness of incorporating the convolutional layer in the MDA-CNN to learn the relationship between a high-fidelity datum and all the available low-fidelity data, the predictions are also made using the simplified framework 10 in FIG. 2 which only learns the relationship between high-fidelity data and corresponding low-fidelity data without including a convolutional layer (such as convolutional section 104 of the MDA-CNN framework 100) in this architecture. Other than that, the architecture of the simplified framework 10 is the same as the MDA-CNN framework 100 used in this problem for a fair comparison. The results shown in squares in FIG. 9 are obtained using the simplified framework 10 in FIG. 2 and the RMSE is 18.6% in Table 3. Using single-fidelity modeling is insufficient due to the insufficiency of HF data. Predictive improvement can be achieved compared with single-fidelity modeling. Without incorporating the convolutional section 104, the prediction accuracy of the simplified framework 10 is not as good as those obtained with the MDA-CNN framework 100.

Next, the computational cost for this problem is discussed. Let WMDA-CNN and WHF denote the total computational cost for multi-fidelity modeling by the MDA-CNN framework 100 and the classical high-fidelity model, respectively. They can be expressed in the following forms:

$${W}_{\text{MDA} - \text{CNN}} = {N}_{L} {w}_{L} + {N}_{H} {w}_{H} + {w}_{T} + {w}_{P} , \qquad \text{(17)}$$

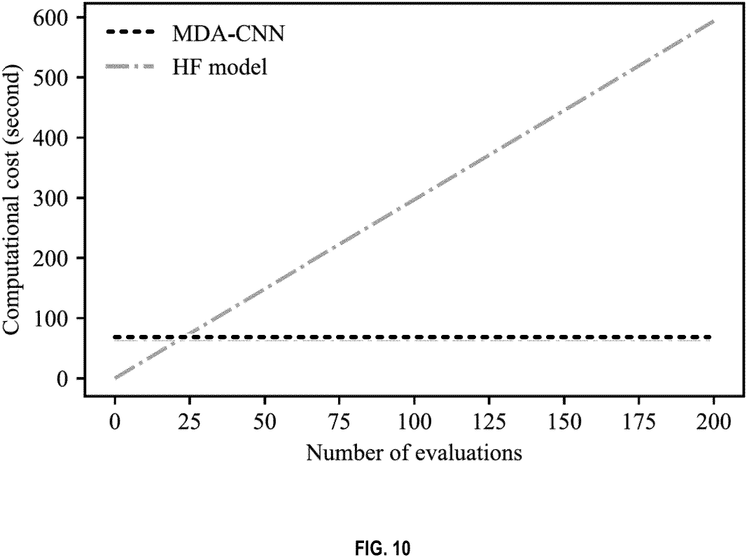

and:

$${W}_{\text{HF}} = {N}_{P} {w}_{H} , \qquad \text{(18)}$$

where w_{L} and w_{H} are the computational cost for obtaining Q_{L} and Q_{H} from a low-computational and high-computational model, respectively, N_{L} and N_{H} are the number of low-fidelity data and high-fidelity data for training, respectively, w_{T} and w_{P} are the computational cost for training and evaluating the MDA-CNN framework 100, respectively, and N_{P} is the number of evaluations (predictions) for the MDA-CNN framework 100 or for the high-fidelity model. The cost w_{T} for training the NN depends on the size of training data and NN architecture (i.e., the number of hidden layers and neurons, etc.). It is a one-time cost. The cost w_{P} for evaluating the NN depends on the NN architecture. It involves activation function and matrix-operation. It is observed for this problem that this cost is almost independent of the number of predictions. For this problem, the computational costs and data sizes are shown in Table 4. The computational cost vs. the number of evaluations is plotted in FIG. 10 according to Eqs. (17) and (18). When the number of evaluations exceeds 22, the more evaluations, the more computational saving can be achieved by using the MDA-CNN framework 100. It should be noted that this overhead suggests that for linear low-dimensional problem, the MDA-CNN framework 100 does not offer computational advantages as very few function evaluations of high-fidelity model is sufficient. However, the MDA-CNN framework 100 has superior efficiency for most engineering applications with nonlinearity and high-dimensionality.

### 4.2. Fatigue Crack Growth Prognosis With Monitoring

In prognostics for engineering materials and systems, both simulation models and experimental measurements are available. Experimental measurements can be used to update the simulation model for more accurate remaining life prediction. In this application, data from simulation models are relatively easy to obtain as the computational complexity is usually not high. Experimental measurements are usually very expensive, but represent the true response of materials and structures. Thus, simulation data is treated as the low-fidelity data and the experimental measurements as the high-fidelity data. Multi-fidelity data aggregation can be applied to predict the crack growth trajectory under fatigue loadings.

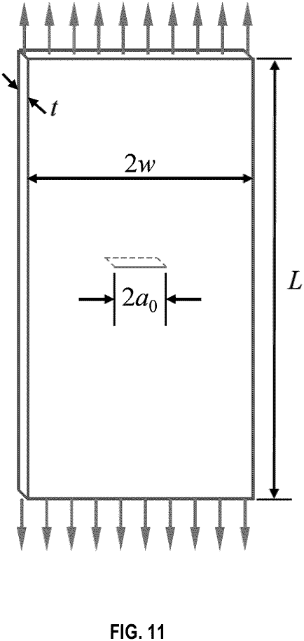

An aluminum 2024-T3 plate with an initial center-through crack under fatigue loading is shown in FIG. 11. The plate has dimensions of width w = 152.4 mm, length L = 558.8 mm, and thickness t = 2.54 mm. The initial crack size is a₀ = 9.0 mm. The cyclic loading is applied with a stress amplitude of 24.14 MPa, frequency of 20 Hz, and stress ratio of 0.2. In total, for this validation example, 68 plates were tested with the same specimen and loading configurations. The experimental data of crack growth trajectories (crack growth vs. loading cycles) were reported. Those trajectories vary from each other due to the material and loading uncertainty. The multi-fidelity problem setup is as follows. A simplified mathematical model (implemented as a Paris’ model) calibrated by historical data is treated as the low-fidelity model. Specifically, the first 10 out of 68 trajectory data are used to fit parameters of the Paris’ model. The fitted model cannot precisely predict the crack growth trajectory of a new specimen due the probabilistic nature of fatigue. However, the Paris’ model can describe the approximate trend of crack growth trajectories under repeated testing circumstances. Thus, the Paris’ model is used as the low-fidelity model. From the remaining dataset, one trajectory is arbitrarily selected as the result of a new test, which is treated as the high-fidelity model to be predicted. Three crack size measurements at earlier stages from that trajectory representing the actual inspection data are used as high-fidelity data. The complete crack growth trajectory is predicted with the low-fidelity model and sparse high-fidelity data.

The Paris’ model is expressed as:

$$\frac{d a}{d N} = c {\left(\text{Δ} K\right)}^{m} , \qquad \text{(19)}$$

where a is the crack length, N is the number of applied loading cycles, and c and m are material parameters. ΔK is stress intensity variation and is calculated by:

$$\text{Δ} K = \text{Δ} σ \sqrt{π \text{} a} \sqrt{sec \left(π \text{} a / w\right)} \qquad \text{(20)}$$

Using the first 10 trajectory data (historical data), model parameters are fitted as c = -26.4723 and m = 2.9308. One of the remaining crack growth trajectories is randomly selected as the target prediction. Three data points from the selected crack growth trajectory are randomly chosen to represent the sparse high-fidelity data obtained from field inspection (red solid dots in FIG. 13).

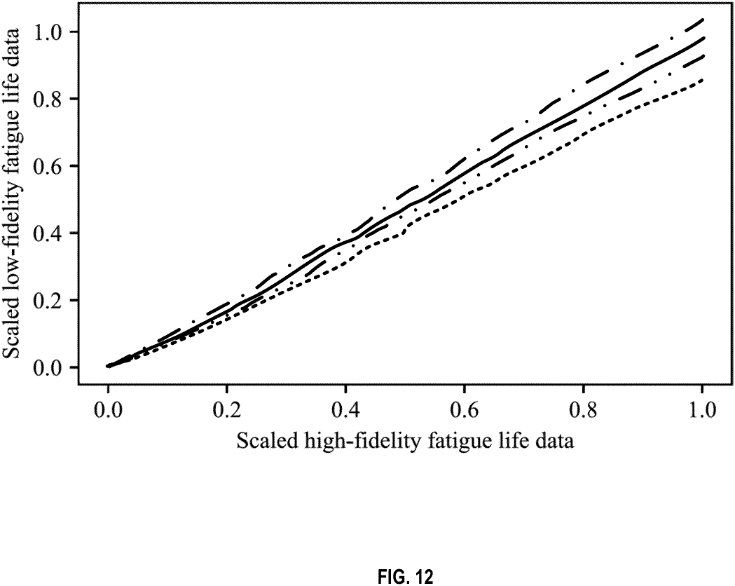

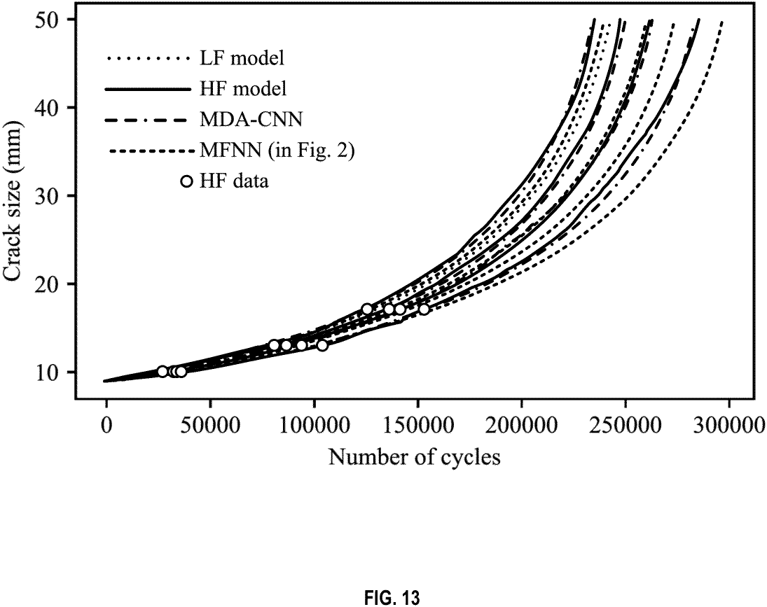

Four trajectories from the remaining dataset are randomly chosen as high-fidelity data. The correlation between scaled low-fidelity data and high-fidelity data at different crack lengths is shown in FIG. 12, which shows a comparison between low-fidelity fatigue life data and high-fidelity fatigue life data at different crack lengths for four fatigue crack growth trajectories. The overall trend is linear. However, slightly nonlinear relationship can be observed locally due to noise from experimental measurements.

The MDA-CNN framework 100 in FIG. 3 is used for the multi-fidelity modeling. The prediction results are shown in FIG. 13. FIG. 13 shows the results of fatigue crack growth trajectories using MDA-CNN. The black sparse dotted line is the Paris’ model calibrated using the first 10 trajectory data. The high-fidelity data are shown in solid lines. The predictions from the MDA-CNN framework 100 are shown in “double-dash single-dot” lines. As shown, the crack growth curve from the Paris’ model deviates from the individual actual trajectories. However, with 3 high-fidelity data (shown as large white dots) and the low-fidelity Paris’ model, accurate predictions of crack growth trajectories can be obtained using the MDA-CNN framework 100. The results obtained using the simplified framework 10 in FIG. 2 (without the convolutional layer) are also shown in FIG. 13 (dense dashed lines). In that case, the predictions are not accurate as those of the MDA-CNN framework 100, especially for the extrapolated fatigue crack growth trajectories where high-fidelity data are not available.

### 5. Discussions

### 5.1. Effect of Convolutional Layer

### 5.1.1. With/Without Convolutional Layer

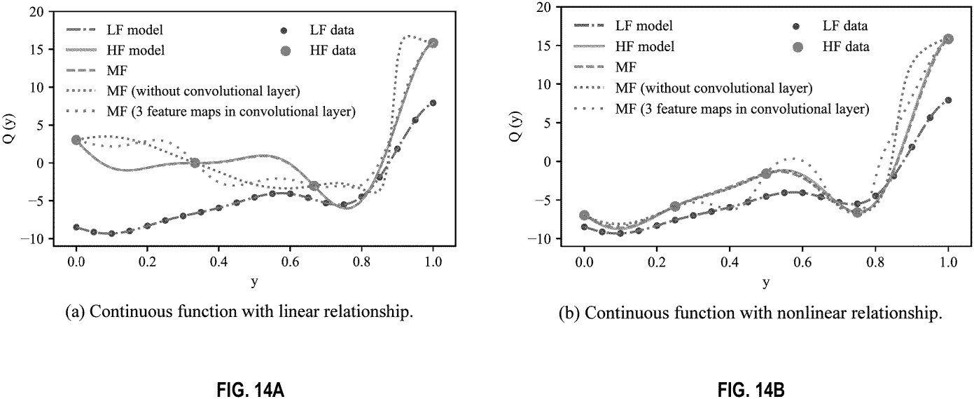

FIGS. 14A and 14B show the comparison between results obtained from the MDA-CNN framework 100 shown in FIG. 3 (e.g., with the convolutional section 104) and the simplified framework 10 shown in FIG. 2 (e.g., without the convolutional layer). FIGS. 14A and 14B respectively correspond to a continuous function with a linear relationship, and a continuous function with a nonlinear relationship for scenarios (a) and (c) in Table 1. The results from the MDA-CNN framework 100 with the convolutional section 104 are shown in dashed lines, and the results from the simplified framework 10 shown in FIG. 2 without the convolutional layer are indicated by a dense dotted line.

As shown, without the convolutional section 104 of the MDA-CNN framework 100, the predicted results from the simplified framework 10 have poor accuracy. This is due to the small amount of high-fidelity data. With the sparse data, it is insufficient to produce an accurate result if only the low-fidelity data with the same input vector y as the available high-fidelity data are used for learning the relationship, (e.g., the relationship shown in FIG. 1A). However, by using the MDA-CNN framework 100 with the convolutional section 104, satisfactory results can be obtained, achieved through utilizing all low-fidelity data and capturing the relationship between a high-fidelity datum with every low-fidelity datum.

### 5.1.2. Number of Feature Maps in Convolutional Layer

The multi-fidelity results from the MDA-CNN framework 100 shown in dashed lines in FIGS. 14A and 14B are obtained with 64 feature maps in the convolutional section 104. To investigate the effect of number of feature maps on the predicted results, the neural networks of both framework (including the deep neural network model 106 within the simplified framework 10 shown in FIG. 2 and the deep neural network model 106 of the MDA-CNN framework 100) are each retrained with 3 feature maps, the results of which are shown in sparse dotted lines. For the investigated examples, the predictions are inaccurate with only 3 feature maps in the convolutional section 104 of the MDA-CNN framework 100. That can be explained as follows. Each feature map function learns a simple localized feature of relationship between low-fidelity data and high-fidelity data. Thus, a sufficient number of feature maps are needed for a complete capture of the relationship.

### 5.2. Effect of Gradient Information

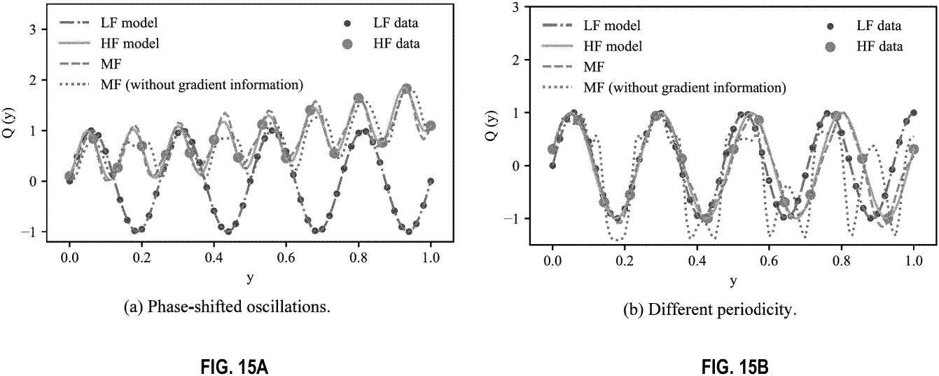

The multi-fidelity prediction results of the MDA-CNN framework 100 shown in FIGS. 5E and 5F (i.e., examples of phase-shifted oscillations and different periodicities) are obtained using the multi-fidelity data matrix 120 configured as shown in FIG. 4C. The first gradient of the low-fidelity model is utilized in the multi-fidelity data matrix 120. This section discusses the scenarios where the multi-fidelity modeling as performed by the MDA-CNN framework 100 is conducted with and without low-fidelity gradient information. The results for the above two examples are shown in FIGS. 15A and 15B, respectively. The dashed lines indicate the results obtained by incorporating the first derivative of the low-fidelity model in the multi-fidelity data matrix 120, and the dense dotted lines are for the results without considering gradient information (i.e., where the multi-fidelity data matrix 120 is configured similarly to the example shown in FIG. 3). It can be observed that the predictions without the low-fidelity gradient information are inaccurate. That can be explained as follows. The high-fidelity model for Eqs. (12) and (14) in Table 1 can be further expressed as:

$${Q}_{H} \left(y\right) = {y}^{2} + {\left[{Q}_{L} \left(y\right) ⋅ cos \left(π / 10\right) + {Q}_{L}^{\left(1\right)} \left(y\right) ⋅ sin \left(π / 10\right) / \left(8 π\right)\right]}^{2} , \qquad \text{(21)}$$

and:

$$\begin{matrix}{Q}_{H} \left(y\right) = \left[cos \left(b y\right) {Q}_{L} \left(y\right) - \frac{1}{a} sin \left(b y\right) {Q}_{L}^{\left(1\right)} \left(y\right)\right] cos \left(π / 10\right) + \\ \left[sin \left(b y\right) {Q}_{L} \left(y\right) + \frac{1}{a} cos \left(b y\right) {Q}_{L}^{\left(1\right)} \left(y\right)\right] sin \left(π / 10\right) ,\end{matrix} \qquad \text{(22)}$$

respectively, where

$$a = 6 \sqrt{2 π} \text{and} b = 6 \sqrt{2 π} - 8 π .$$

The high-fidelity model is a function of not only the low-fidelity model itself but also its first derivative. If no low-fidelity gradient information is provided for multi-fidelity modeling, the present datasets are insufficient for the deep neural network model 106 of the MDA-CNN framework 100 to learn the correct relationship. In previous approaches, this problem is solved by incorporating Q_{L}(y - τ) where τ is the delay and viewing that as an implicit approximation of the first derivative. The selection of optimal value for the time delay τ is critical and problem-dependent. The multi-fidelity modeling fails without an optimal τ. However, by explicitly incorporating the first derivative information of the low-fidelity model in the MDA-CNN framework 100, the time delay τ can be avoided. Thus, the MDA-CNN framework 100 can be applied with more flexibility for different problems.

### 6. Summary

This disclosure presents the MDA-CNN framework 100 for multi-fidelity modeling. The MDA-CNN framework 100 includes the multi-fidelity data compiling section 102, the convolutional section 104 that considers the local receptive field 130, and the deep neural network model 106 for mapping low-fidelity data to high-fidelity data. The MDA-CNN framework 100 discussed herein fully exploits the relationship between low-fidelity data and high-fidelity data. That is, the MDA-CNN framework 100 aims to capture and utilize the relationship between any high-fidelity datum with all available low-fidelity data, instead of just a point-to-point relationship (i.e., a high-fidelity datum with one corresponding low-fidelity datum), achieved by incorporating all the low-fidelity data and a sliding local receptive field connected to hidden neurons in the convolutional section 104 across the entire range of low-fidelity data. The MDA-CNN framework 100 can be easily adapted for scenarios with multiple low-fidelity models, high-dimensional inputs, incorporating additional low-fidelity information, etc. by properly designing the multi-fidelity data matrix 120.

This disclosure has demonstrated the viability of the MDA-CNN framework 100 using extensive numerical examples including linear and nonlinear relationship between low-fidelity functions and high-fidelity functions, discontinuous functions, oscillation functions with phase shift and different periodicities, and high-dimensional models. This disclosure also provides a comparison between results achieved with/without the convolutional layer, and with/without additional low-fidelity information (derivatives). After validation, the MDA-CNN framework 100 is applied to solve two engineering problems with different types of levels of fidelities, stress prediction with coarse mesh (low-fidelity) vs. fine mesh (high-fidelity) in finite element analysis, and fatigue crack growth with simplified physics model vs. experimental data. In both numerical and engineering examples, the most accurate results can be obtained with the MDA-CNN framework 100 discussed herein.

The MDA-CNN framework 100 outlined in this disclosure is a fundamental model that introduces convolutional neural networks (CNNs) into multi-fidelity (and multi-source) modeling time. Several future research directions are presented based on the current study. First, one implementation of the MDA-CNN framework 100 presented in this disclosure shows the convolutional section 104 having one convolutional layer and zero pooling layers. This is due to the relatively low dimension of data investigated in this work. For higher dimensional and more complicated data, additional convolutional layers and corresponding pooling layers can be included within the convolutional section 104. Second, the local receptive field 130 “sliding down” or otherwise advancing along the multi-fidelity data matrix 120 helps to learn the relationship between high-fidelity data and low-fidelity data locally and sequentially. Other manners of moving the local receptive field 130 can be explored for a more effective relationship capturing, for example, noncontinuous sliding schemes. Third, the uncertainty quantification is important in multi-fidelity modeling. The work presented in this disclosure uses Convolutional Neural Networks (CNNs) for deterministic results. However, the MDA-CNN framework 100 can be extended to achieve probabilistic multi-fidelity modeling. The deep neural network model 106 outlined in this disclosure can be further developed for a probabilistic approach by using a Bayesian CNN or another implementation of a Bayesian neural network. Fourth, in example implementations shown herein, the high-fidelity data and low-fidelity data are preprocessed to form a rectangular multi-fidelity data matrix 120 in order for the deep neural network model 106 to learn the relationship between fidelities. To achieve this goal, the high-fidelity data and low-fidelity data are limited to be collocated. That means, for any high-fidelity data, there must be a corresponding low-fidelity data which has the same inputs. That may not hold for some other engineering applications. As such, modifications may be made to the multi-fidelity data compiling section 102 to develop the multi-fidelity data matrix 120 accordingly. For example, the inputs of low-fidelity data and high-fidelity data have different dimensions or variables.

### 7. Methods

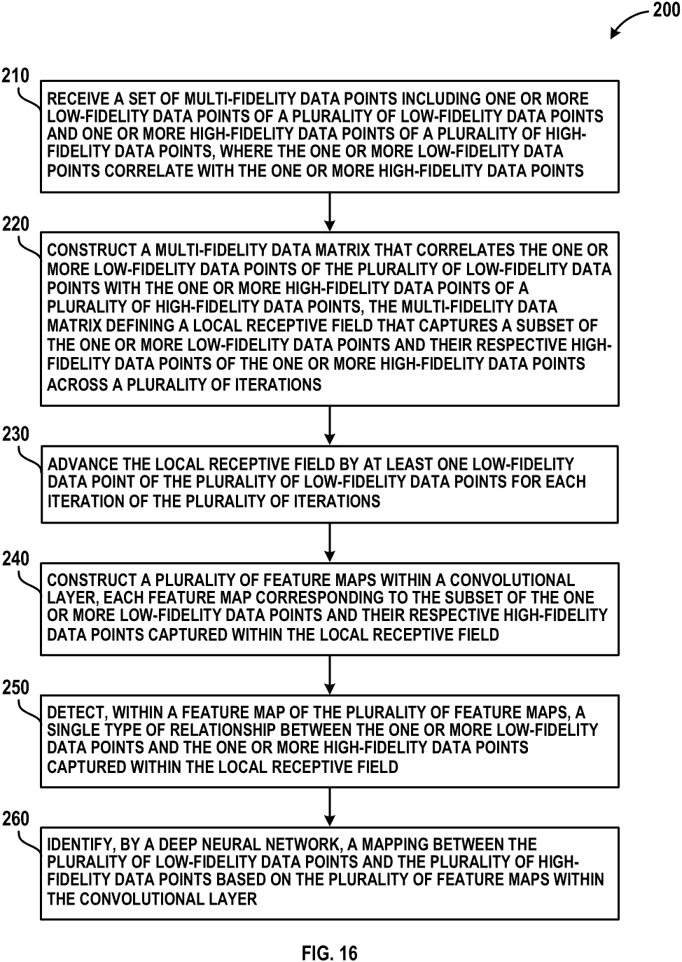

FIG. 16 shows a method 200 for learning relationships between high-fidelity data and the low-fidelity data by the MDA-CNN framework 100 outlined herein. Step 210 of method 200 includes receiving a set of multi-fidelity data points including one or more low-fidelity data points of a plurality of low-fidelity data points and one or more high-fidelity data points of a plurality of high-fidelity data points, where the one or more low-fidelity data points correlate with the one or more high-fidelity data points. Step 220 of method 200 includes constructing a multi-fidelity data matrix that correlates the one or more low-fidelity data points of the plurality of low-fidelity data points with the one or more high-fidelity data points of a plurality of high-fidelity data points, the multi-fidelity data matrix defining a local receptive field that captures a subset of the one or more low-fidelity data points and their respective high-fidelity data points of the one or more high-fidelity data points across a plurality of iterations. Step 230 of method 200 includes advancing the local receptive field by at least one low-fidelity data point of the plurality of low-fidelity data points for each iteration of the plurality of iterations. Step 240 of method 200 includes constructing a plurality of feature maps within a convolutional layer, each feature map corresponding to the subset of the one or more low-fidelity data points and their respective high-fidelity data points captured within the local receptive field. Step 250 of method 200 includes detecting, within a feature map of the plurality of feature maps, a single type of relationship between the one or more low-fidelity data points and the one or more high-fidelity data points captured within the local receptive field. Step 260 of method 200 includes identifying, by a deep neural network, a mapping between the plurality of low-fidelity data points and the plurality of high-fidelity data points based on the plurality of feature maps within the convolutional layer.

### 8. Computer-Implemented System and Example Device

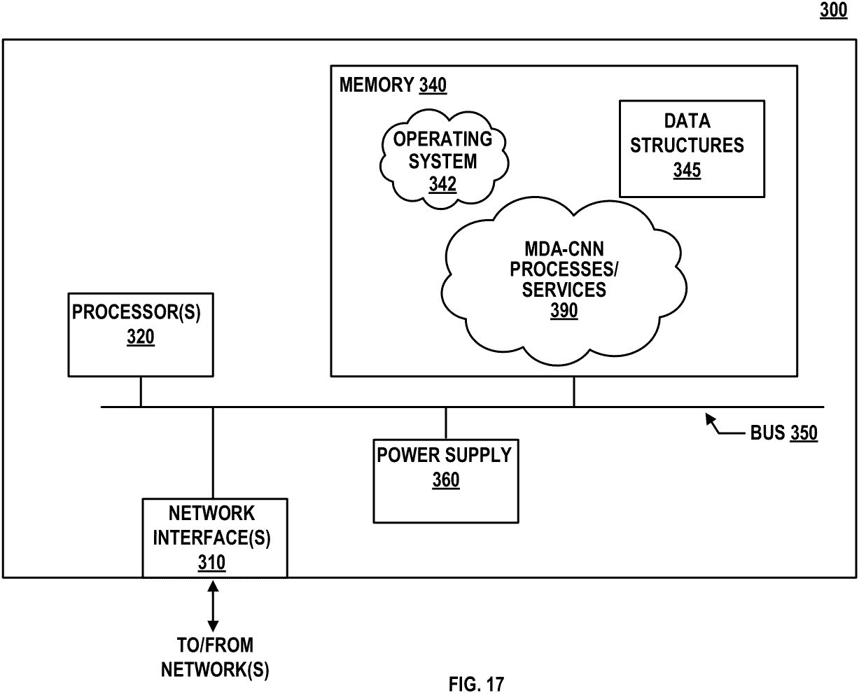

FIG. 17 is a schematic block diagram of an example device 300 that may be used with one or more embodiments described herein, e.g., as a component of MDA-CNN framework 100 shown in FIG. 3 and implementing aspects of method 200.

Device 300 includes one or more network interfaces 310 (e.g., wired, wireless, PLC, etc.), at least one processor 320, and a memory 340 interconnected by a system bus 350, as well as a power supply 360 (e.g., battery, plug-in, etc.).

Network interface(s) 310 include the mechanical, electrical, and signaling circuitry for communicating data over the communication links coupled to a communication network. Network interfaces 310 are configured to transmit and/or receive data using a variety of different communication protocols. As illustrated, the box representing network interfaces 310 is shown for simplicity, and it is appreciated that such interfaces may represent different types of network connections such as wireless and wired (physical) connections. Network interfaces 310 are shown separately from power supply 360, however it is appreciated that the interfaces that support PLC protocols may communicate through power supply 360 and/or may be an integral component coupled to power supply 360.

Memory 340 includes a plurality of storage locations that are addressable by processor 320 and network interfaces 310 for storing software programs and data structures associated with the embodiments described herein. In some embodiments, device 300 may have limited memory or no memory (e.g., no memory for storage other than for programs/processes operating on the device and associated caches).

Processor 320 comprises hardware elements or logic adapted to execute the software programs (e.g., instructions) and manipulate data structures 345. An operating system 342, portions of which are typically resident in memory 340 and executed by the processor, functionally organizes device 300 by, inter alia, invoking operations in support of software processes and/or services executing on the device. These software processes and/or services may include MDA-CNN processes/services 390 that implements aspects of the MDA-CNN framework 100 and method 200 described herein, including formulating the convolutional section 104 and the deep neural network model 106 at the processor 320. Note that while MDA-CNN processes/services 390 is illustrated in centralized memory 340, alternative embodiments provide for the process to be operated within the network interfaces 310, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the MDA-CNN processes/services 390 is shown as a standalone process, those skilled in the art will appreciate that this process may be executed as a routine or module within other processes.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A system comprising:
a processor in communication with a memory, the memory including instructions executable by the processor to:
construct a multi-fidelity data matrix that correlates one or more low-fidelity data points of a plurality of low-fidelity data points with one or more high-fidelity data points of a plurality of high-fidelity data points, the multi-fidelity data matrix defining a local receptive field that captures a subset of the one or more low-fidelity data points and their respective high-fidelity data points of the one or more high-fidelity data points across a plurality of iterations;
construct a plurality of feature maps within a convolutional layer, each feature map of the plurality of feature maps corresponding to the subset of the one or more low-fidelity data points and their respective high-fidelity data points captured within the local receptive field; and
identify, by a deep neural network, a mapping between the plurality of low-fidelity data points and the plurality of high-fidelity data points based on the plurality of feature maps within the convolutional layer.

2. The system of claim 1, the memory further including instructions executable by the processor to:
advance the local receptive field by at least one low-fidelity data point of the plurality of low-fidelity data points for each iteration of the plurality of iterations.

3. The system of claim 2, the convolutional layer comprising a plurality of hidden neurons, each hidden neuron of the plurality of hidden neurons corresponding to a respective iteration of the plurality of iterations as the processor advances the local receptive field by at least one low-fidelity data point of the plurality of low-fidelity data points for each iteration of the plurality of iterations.

4. The system of claim 1, the memory further including instructions executable by the processor to:
detect, within a feature map of the plurality of feature maps, a single type of relationship between the one or more low-fidelity data points and the one or more high-fidelity data points captured within the local receptive field.

5. The system of claim 1, wherein the multi-fidelity data matrix comprises more than one low-fidelity model and more than one high-fidelity model that corresponds with each respective low-fidelity data point of the plurality of low-fidelity data points.

6. The system of claim 1, wherein the multi-fidelity data matrix comprises one or more derivative functions that correspond with each respective low-fidelity data point of the plurality of low-fidelity data points.

7. The system of claim 1, wherein the multi-fidelity data matrix comprises more than one dimension for each respective low-fidelity data point of the plurality of low-fidelity data points and more than one more than one dimension for each respective high-fidelity data point of the plurality of high-fidelity data points that corresponds with each respective low-fidelity data point of the plurality of low-fidelity data points.

8. The system of claim 1, the deep neural network comprising:
a skip connection that learns a linear mapping between the plurality of low-fidelity data points and the plurality of high-fidelity data points; and
a plurality of fully-connected layers that learn a non-linear mapping between the plurality of low-fidelity data points and the plurality of high-fidelity data points.

9. A method comprising:
constructing, at a processor in communication with a memory, a multi-fidelity data matrix that correlates one or more low-fidelity data points of a plurality of low-fidelity data points with one or more high-fidelity data points of a plurality of high-fidelity data points, the multi-fidelity data matrix defining a local receptive field that captures a subset of the one or more low-fidelity data points and their respective high-fidelity data points of the one or more high-fidelity data points across a plurality of iterations;
constructing, at a processor in communication with a memory, a plurality of feature maps within a convolutional layer formulated at the processor, each feature map of the plurality of feature maps corresponding to the subset of the one or more low-fidelity data points and their respective high-fidelity data points captured within the local receptive field; and
identifying, by a deep neural network formulated at the processor, a mapping between the plurality of low-fidelity data points and the plurality of high-fidelity data points based on the plurality of feature maps within the convolutional layer.

10. The method of claim 9, further comprising:
advancing the local receptive field by at least one low-fidelity data point of the plurality of low-fidelity data points for each iteration of the plurality of iterations.

11. The method of claim 10, the convolutional layer including a plurality of hidden neurons, each hidden neuron of the plurality of hidden neurons corresponding to a respective iteration of the plurality of iterations as the processor advances the local receptive field by at least one low-fidelity data point of the plurality of low-fidelity data points for each iteration of the plurality of iterations.

12. The method of claim 9, further comprising:
detecting, within a feature map of the plurality of feature maps, a single type of relationship between the one or more low-fidelity data points and the one or more high-fidelity data points captured within the local receptive field.

13. The method of claim 9, the multi-fidelity data matrix comprising more than one low-fidelity model and more than one high-fidelity model that corresponds with each respective low-fidelity data point of the plurality of low-fidelity data points.

14. The method of claim 9, the multi-fidelity data matrix comprising one or more derivative functions that correspond with each respective low-fidelity data point of the plurality of low-fidelity data points.

15. The method of claim 9, the multi-fidelity data matrix including more than one dimension for each respective low-fidelity data point of the plurality of low-fidelity data points and more than one more than one dimension for each respective high-fidelity data point of the plurality of high-fidelity data points that corresponds with each respective low-fidelity data point of the plurality of low-fidelity data points.

16. A system comprising:
a processor in communication with a memory, the memory including instructions executable by the processor to:
access a set of multi-fidelity data points comprising one or more low-fidelity data points of a plurality of low-fidelity data points and one or more high-fidelity data points of a plurality of high-fidelity data points, where the one or more low-fidelity data points correlate with the one or more high-fidelity data points; and
identify, by a deep neural network, a mapping between the plurality of low-fidelity data points and the plurality of high-fidelity data points, the deep neural network comprising:
a skip connection that learns a linear mapping between the plurality of low-fidelity data points and the plurality of high-fidelity data points; and
a plurality of fully-connected layers that learn a non-linear mapping between the plurality of low-fidelity data points and the plurality of high-fidelity data points.

17. The system of claim 16, the memory further including instructions executable by the processor to:
construct a multi-fidelity data matrix that correlates the one or more low-fidelity data points of the plurality of low-fidelity data points with the one or more high-fidelity data points of the plurality of high-fidelity data points, the multi-fidelity data matrix defining a local receptive field that captures a subset of the one or more low-fidelity data points and their respective high-fidelity data points of the one or more high-fidelity data points across a plurality of iterations.

18. The system of claim 17, the memory further including instructions executable by the processor to:
construct a plurality of feature maps within a convolutional layer, each feature map corresponding to the subset of the one or more low-fidelity data points and their respective high-fidelity data points captured within the local receptive field;
where the deep neural network identifies the mapping between the plurality of low-fidelity data points and the plurality of high-fidelity data points based on the plurality of feature maps within the convolutional layer.

19. The system of claim 17, the memory further including instructions executable by the processor to:
advance the local receptive field by at least one low-fidelity data point of the plurality of low-fidelity data points for each iteration of the plurality of iterations.

20. The system of claim 19, the convolutional layer including a plurality of hidden neurons, each hidden neuron of the plurality of hidden neurons corresponding to a respective iteration of the plurality of iterations as the processor advances the local receptive field by at least one low-fidelity data point of the plurality of low-fidelity data points for each iteration of the plurality of iterations.
